(19) United States
(12) Patent Application Publication
(10) Pub. No.: US 2010/0139110 A1
(43) Pub. Date: Jun. 10, 2010

(54) MULTI-PURPOSE ELECTRICIAN'S MEASURING TAPE

(76) Inventor: ANTONIO GERMAIN, Castleberry, FL (US)

Correspondence Address: Innovative IP, LLC, P.O. Box 217, New Smyrna Beach, FL, 32170, US

(21) Appl. No.: 12/331,809

(22) Filed: Dec. 10, 2008

(51) Int. Cl. G01B 3/10

(52) U.S. Cl. 33/755

(57) ABSTRACT

An electrician's reference device, wherein accurate phase determinations may be simply identified therefrom, and wherein conduit bending measurement calculations may be confidently established, via a quick, consistent, easy and convenient method incorporated into a commonly used tool configuration.

### FIELD

The present disclosure relates generally to tools, and more particularly, to a multi-purpose electrician's measure tape and method thereof, wherein an easily accessible reference system facilitates accurate and efficient installation of wiring.

### BACKGROUND

Although an electrician is one of many contractors that contributes the final realization of a habitable building or structure, the electrical wiring is a critical component. Building wiring provides power, thereby enhancing the usefulness of the building; however, failure to properly install such wiring can render dangerous and even deadly results. To that end, a National Electrical Code (NEC) has been formulated by the National Fire Protection Association (NFPA) in order that buildings and structures are safely wired, with least risk to inhabitants. Once the NEC is adopted as law in a given geographic region, each permitted job is inspected for compliance. In such an inspection, installation aspects are reviewed for conformity in view of the NEC code and the plans.

In a typical installation site, an electrician is provided with a set of plans, or blueprints, wherein receptacles and devices are noted. Smaller circuits are generally utilized for general purpose receptacles and lighting, and higher ratings are generally dedicated to one major appliance, such as an air conditioner or water heater. Each such power destination is designated as high or low voltage, and depending upon that designation, and the appropriate phase, a proper wire selection must be made by the electrician for installation between the circuit panel and the destination receptacle or device, for example.

Electricians must necessarily view the two-dimensional plans and correspondingly create the correct three dimensional installation. For example, conventional symbols and notations are used to represent intended electrical appliances and equipment. The voltage and circuit is typically defined on the plans, but it is left for the electrician to determine the proper phase. Color coding of wire is a critical feature. For example, phase wire generally may be black, red, orange, brown, yellow, and blue. Neutral wire is gray or white, and grounding wire is green or green striped. Each phase is associated with particular wire colors, wherein improper installation can result in not only a failed inspection, but a dangerous structure at risk for electrical fire.

In a typical three-phase system, for example, phase determination for a particular circuit is usually accomplished by dividing the circuit number by the number six. The remainder identifies the phase, by convention, which accordingly dictates the color wire to be utilized for that circuit at the identified voltage, wherein the normal phasing of a three phase system is A, B, C, left to right, top to bottom. A typical electrician, therefore, must either memorize the phases A, B or C for each of the 99 or so circuits per panel (typically, approximately 80), or the phase must be calculated, on the spot, during installation. Either way, human error disadvantageously introduces error at an identifiable frequency.

Another installation task routinely faced by an electrician is conduit bending. Conduit is a protective, insulative tube through which electrical wires are fed. As an electrician progresses through a job, he must not only identify the correct circuit and voltage from the plans, and calculate the appropriate phase, but he must also calculate the necessary conduit lengths required to enable extension across a particular length, and with the necessary angular bends to traverse a given path. That is, in order to determine the appropriate length of conduit to cut, an electrician must be able to compensate for the shrinkage that will occur from each angular bend.

For example, the most commonly specified bend is a 30°×30° bend. Most electricians therefore readily recite that such a bend results in shrinkage of ¼ per inch of offset depth, and therefore know that a multiplier of 2.0 is necessary to compensate therefore. However, there are a plurality of offset angles, or bends, generally four types in Code, that may be specified and/or required by a given plan or installation, wherein these less frequently utilized bends can be disadvantageously miscalculated, resulting in materials waste and installation time loss and delay.

Therefore, it is readily apparent that there is a need for an electrician's reference device, wherein accurate phase determinations may be simply identified therefrom, and wherein conduit bending measurement calculations may be confidently established, via a quick, consistent, easy and convenient method incorporated into a commonly used tool configuration, thereby avoiding the above-discussed disadvantages.

### BRIEF SUMMARY

Briefly described, in a preferred embodiment, the present device overcomes the above-mentioned disadvantages and meets the recognized need for such a device by providing a multi-purpose electrician's measuring tape device, wherein a first side of a retractable tape is adapted with a phase determination reference guide, and wherein a second side of the retractable tape is adapted with conduit bending reference data.

According to its major aspects and broadly stated, in its preferred form, the present device is a multi-purpose electrician's measuring tape that enables a user to quickly, easily, and confidently determine the appropriate phase color installation of wiring to a given device to be installed to a given circuit, and that further enables a user to quickly, easily, and confidently determine the appropriate length of a particular diameter conduit necessary to accomplish an identified traverse with particular bends therewithin, each essentially without risk of improper installation, code violation, and/or materials waste.

More specifically, the device of the present disclosure in its preferred form is a multi-purpose electrician's measuring tape device comprising a self-retractable measuring tape, preferably a 30 foot long, one-inch wide tape, preferably double-coated with nylon for durability, preferably with a magnetic tip and double end hook for ease of use, and also preferably with a rubberized case for ease of grip. The tape is first, therefore, adapted for use as a conventional measuring tape.

Additionally, the first side of the tape is adapted with a three phase wiring reference system, for a second use. That is, each numerical measurement reference number from one to ninety-nine is color coded to allow for quick recognition of wire color and phase, wherein each numerical measurement reference number directly correlates to the respective circuit number, and wherein the color of the number corresponds to the wire color, phase, and voltage.

Further, the second side of the tape is adapted with a conduit bending reference system, for still another use with electrical metal tubing (EMT), rigid metal conduit (RMC), and intermediate metal conduit (IMT). That is, an offset table with provision of offset angle, multiplier, and shrinkage per inch of offset depth is preferably provided, and an offset angle table with provision of offset depth, distance between marks, and shrinkage per amount is also preferably provided. The offset angles, distance between marks, and shrinkage amounts may therefore be consistently known.

A feature and advantage of the present device is therefore the ability of such a device to facilitate proper and code compliant installation of electrical wiring.

Another feature and advantage of the present device is the ability of such a device to facilitate quick, consistent conduit bending.

Another feature and advantage of the present device is the ability of such a device and method to enable easy reference with necessitating carriage of any additional item or tool, thereby enabling efficiency of transport.

Still another feature and advantage of the present device is its ability to perform multiple functions, including provision and delivery of accurate direct length measurements, phase determination identifications, and conduit manipulation reference data.

Yet another feature and advantage of the present device is the ability of such a device to assist in the avoidance of improper wiring, inspection failure, and/or risk of electrical damage.

Still yet another feature and advantage of the present device is its ability to retain functionality in any environmental condition at any location.

Still another feature and advantage of the present device is its ability to essentially eliminate the need for the electrician to memorize or otherwise perform on-site calculations for proper phase determination.

Another feature and advantage of the present device is its ability to essentially eliminate the need for the electrician to memorize or otherwise perform on-site calculations for proper conduit bending.

Yet still another feature and advantage of the present device is its ability to perform via traditional retractable measurement tape technique.

These and other features and advantages of the device will become more apparent to one skilled in the art from the following description and claims when read in light of the accompanying drawings.

### BRIEF DESCRIPTION OF THE DRAWINGS

The present invention will be better understood by reading the Detailed Description of the Preferred and Alternate Embodiments with reference to the accompanying drawing figures, in which like reference numerals denote similar structure and refer to like elements throughout, and in which:

FIG. 1 is a multi-purpose electrician's measuring tape device, according to the preferred embodiment, showing a representative segment of a first side of the tape;

FIG. 2A is the multi-purpose electrician's measuring tape device of FIG. 1, showing a first representative segment of a second side of the tape;

FIG. 2B is the multi-purpose electrician's measuring tape device of FIG. 1, showing a second representative segment of the second side of the tape;

FIG. 3 is the multi-purpose electrician's measuring tape device of FIG. 1, showing a case;

FIG. 4 is a partial, front representational view of an exemplary circuit panel, showing a representative phase arrangement;

FIG. 5 is a perspective view of an exemplary length of installed conduit, showing representative bends; and

FIG. 6 is a multi-purpose electrician's measuring tape device, according to an alternate embodiment, showing a segment of a first side of the tape.

### DETAILED DESCRIPTION OF THE PREFERRED AND ALTERNATE EMBODIMENTS

In describing the preferred and alternate embodiments of the present invention, as illustrated in the figures and/or described herein, specific terminology is employed for the sake of clarity. The invention, however, is not intended to be limited to the specific terminology so selected, and it is to be understood that each specific element includes all technical equivalents that operate in a similar manner to accomplish similar functions.

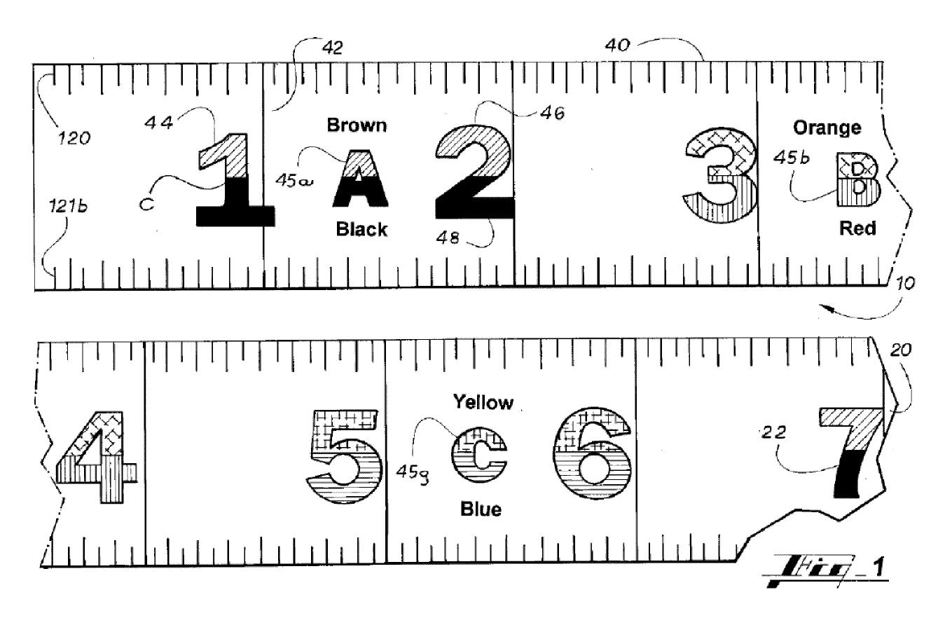

Referring now to FIGS. 1-3, the present invention in the preferred embodiment is multi-purpose electrician's measuring tape device 10, and method thereof, generally comprising tape 20 and case 30, wherein markings 22 visibly displayed on tape 20 facilitate the multiplicity of use for tape device 10. That is, first side 40 of tape 20 is preferably adapted with phase determination reference guide 42, and second side 60 of tape 20 is preferably adapted with conduit bending reference data 62.

According to the preferred embodiment, tape 20 of device 10 is self-retractable, according to known and readily available mechanisms available in the art, and is preferably a 30 foot long, one-inch wide tape, preferably double-coated with nylon for durability, preferably with magnetic tip 80 and double end hook 82 for ease of use, and also wherein case 30 is rubberized for ease of grip and rugged durability. It should be noted, however, that any or all of the foregoing traditional tape features may be excluded without departing from the intended scope of the present disclosure. That is, device 10 could be alternately non-self-retractable and/or could be of a length greater or less than 30 feet. Moreover, the width of tape 20 could be greater or less than one inch, and tape 20 could be manufactured from any suitable material, whether or not coated with nylon. Still further, tape 20 could be fashioned without magnetic tip 80 and/or double end hook 82, as desired. Additional features, too, could be added without departing from the spirit and scope of the disclosure, such as laser-assisted measurement features, leveling components, and/or any other accessory feature useful during typical measurement projects.

It is therefore the format of tape 20, or more specifically, markings 22 displayed thereon that improves the functionality of device 10. Markings 22 preferably comprise phase determination reference guide 42 on first side 40 of tape 20 and conduit bending reference data 62 on second side 60 of tape 20.

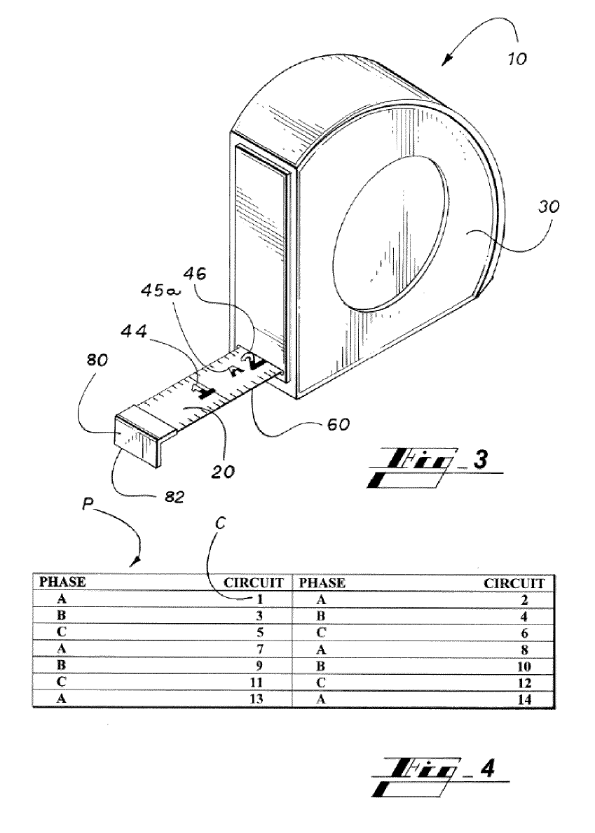

Phase determination reference guide 42 is preferably configured for use as a three phase wiring reference system. With particular reference to FIG. 1, a representative portion of guide 42 is shown, wherein each numerical measurement reference character 44 (inches, as shown) is preferably colorized, preferably including numbers ranging from one to ninety-nine. Although greater or fewer numbers could be systematically colorized without departing from the intended scope of the present disclosure, it is recognized that most circuit panels P, such as representatively depicted in FIG. 4, are provided with an average number of eighty circuits, such that coloration of numerical measurement reference characters 44 up to one hundred is more than adequate for most applications. That is, the preferred color-coding scheme facilitates quick recognition of wire color and phase, wherein each numerical measurement reference character 44 directly correlates to the respective circuit number C, and wherein the coloration of each numerical measurement reference character 44 corresponds to the wire color, phase, and voltage.

Preferably, each numerical measurement reference character 44 is displayed in two colors, high voltage color 46 and low voltage color 48. It is preferred that high voltage color 46 is the upper, or high, color for each particular character 44, and that low voltage color 48 is the bottom, or low, color. In such an arrangement, recollection regarding which color code relates to high voltage is confirmed by “high” placement of high voltage color 46. Thus, as noted, the preferred color-coding scheme facilitates quick recognition of wire color and phase, wherein each numerical measurement reference character 44 directly correlates to respective circuit number C, and wherein high voltage color 46 and low voltage color 48 correspond to the wire color, phase, and voltage. Accordingly, the preferred color scheme denotes plurality of high voltage colors 46 to comprise brown, orange, and yellow wires, respectively A, B, and C phases, and further denotes plurality of low voltage colors 48 to comprise black, red, and blue wires, respectively A, B, and C phases.

Referring again to representative segment of tape 20 in FIG. 1, the numerical measurement reference characters 44 at the one inch and two inch marks, for example, comprise upper or high voltage color 46 of brown and bottom or low voltage color 48 of black. Accordingly, for a high voltage installation at circuit one or circuit two, a brown wire would be properly utilized, and for a low voltage installation, a black wire would be properly utilized. Additionally, “A” phase is visually reconfirmed by its correspondingly colorized placement of phase indicator 45 between the two numerical measurement reference characters. By way of further example, for installation to circuit three or circuit four, for a high voltage electrical component, orange wire would be properly utilized and for a low voltage installation, red wire would be correct, with “B” phase reconfirmed by phase indicator 45b. And again, as a further example, for installation of wiring to circuit five or six, for a high voltage installation, yellow wire would be appropriate, and for a low voltage component, blue wire would be properly utilized, confirming “C” phase with phase indicator 45c. This preferred coloration pattern thus continues in such a manner that an electrician may simply pull out tape 20, view the numerical measurement reference character 44 displayed thereon that corresponds to the relevant circuit number to which the component wiring is to be installed, and immediate visual confirmation of color and phase is provided, without any need for calculation.

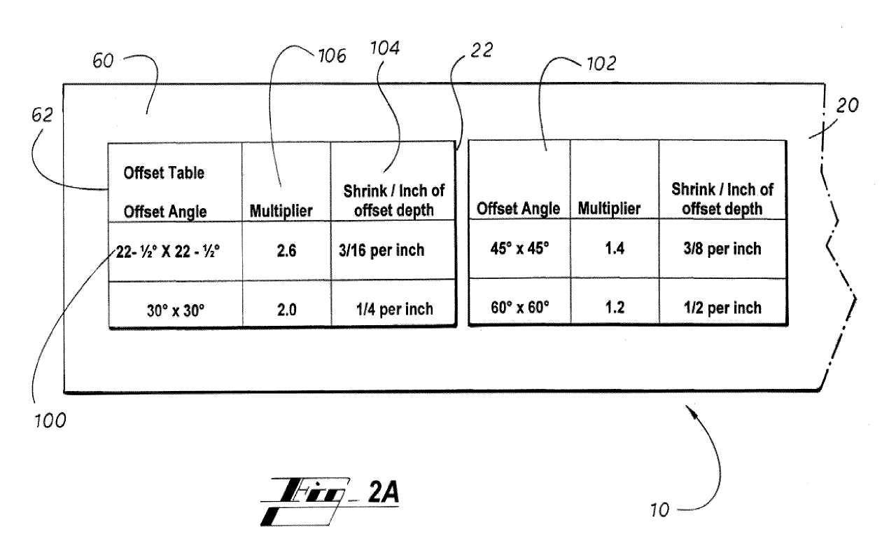

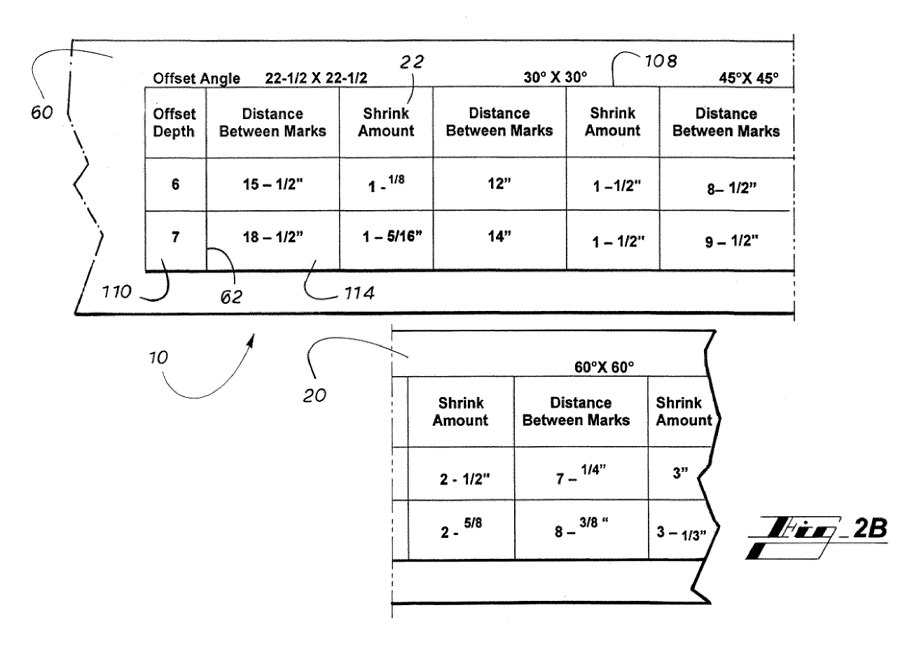

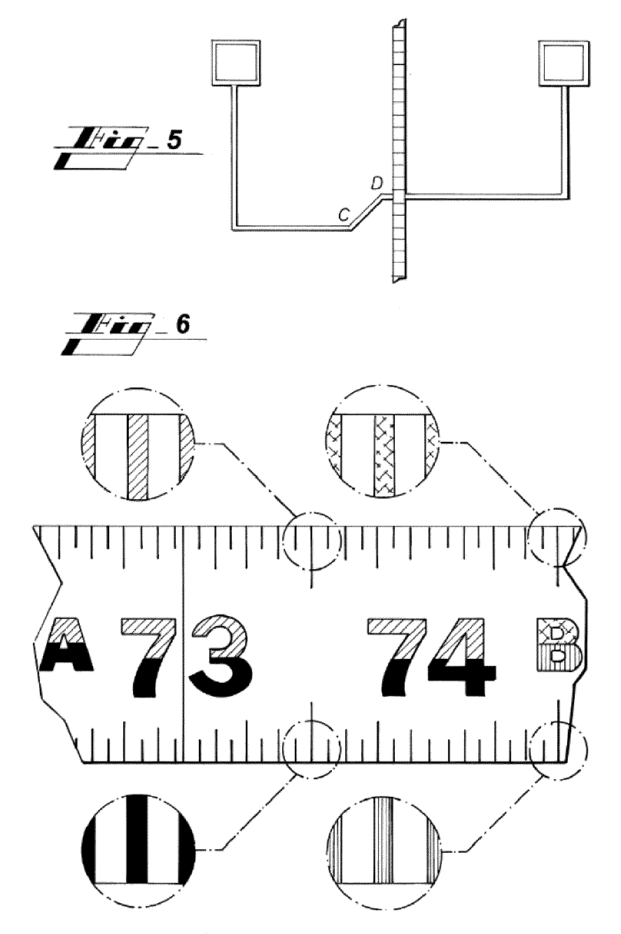

As an even further useful improvement, markings 22 of device 10 preferably further comprise conduit bending reference data 62 on second side 60 of tape 20, wherein conduit bending reference data 62 is adapted for use with electrical metal tubing (EMT), rigid metal conduit (RMC), and intermediate metal conduit (IMC). Referring now to FIGS. 2A and 2B, preferably, a plurality of offset angles 100 is referenced, comprising Code angles 22½°×22½°, 30°×30°, 45°×45°, and 60°×60° wherein necessary measurement data is provided for accurate marking and formation of essentially any bend, B, such as depicted in representative FIG. 5.

According to the preferred embodiment, for each of plurality of offset angles 100, table 102 (representatively shown in FIG. 2A) conveniently displays expected shrinkage per inch of offset depth 104 and multiplier 106. In such manner, an electrician may quickly confirm the necessary measurement compensations that must be factored in view of the shrinkage impact, again without requiring estimation or memorization; thus avoiding miss-cuts and materials waste, even for novice electricians. Additionally, and further according to the preferred embodiment, for each plurality of offset angles 100, table 108 (representatively shown in FIG. 2B) conveniently displays correlating offset depths 110, shrinkage amounts 114, and distance between marks 112, in order that bends may be accurately placed along the length of the conduit CD in view of the necessary offset depth. Again, estimation and memorization of relationships between the factors is eliminated, wherein even a novice electrician may accurately read and efficiently perform a selected and/or directed conduit bending and installation task.

In an alternate embodiment, as depicted in FIG. 6, markings 22 on tape 20 could be alternately configured, wherein phase indicators 45a, 45b, and 45c may be displayed prior to the numerical measurement reference characters 44 for the circuit C corresponding to the phase. Even further alternate positional configurations could be utilized for phase indicators 45a, 45b, and 45c, as desired, without departing from the intended scope of the present disclosure. Moreover, measurement delineations 121a, 121b defined proximate the side edges of tape 20 could be displayed with coloration corresponding to the phase coloration scheme, as desired, wherein, for example, although not depicted, with reference to FIG. 1, each of the measurement delineations 121a, 121b from leading edge 120 of tape 20 to the two-inch reference character 44, could be correspondingly colorized, such that upper measurement delineations 121a could be brown and lower measurement delineations 121b could be black.

Having thus described exemplary embodiments of the present invention, it should be noted by those skilled in the art that the within disclosures are exemplary only, and that various other alternatives, adaptations, and modifications may be made within the scope of the present invention. Accordingly, the present invention is not limited to the specific embodiments illustrated herein, but is limited only by the following claims.

I claim:

1. A multi-purpose electrician's measuring tape device, comprising:
a case; and
a measuring tape retractably carried within said case, said measuring tape having a first side and a second side,
said first side of said measuring tape adapted with a three-phase electrical wiring determination reference guide.

2. The multi-purpose electrician's measuring tape device of claim 1, wherein said second side of the measuring tape is adapted with conduit bending reference data.

3. The multi-purpose electrician's measuring tape device of claim 1, wherein said electrical wiring phase determination reference guide further comprises circuit phase and wire color reference data.

4. The multi-purpose electrician's measuring tape device of claim 2, wherein said conduit bending reference data further comprises offset angle shrinkage data.

5. The multi-purpose electrician's measuring tape device of claim 1, wherein said measuring tape is self-retracting.

6. The multi-purpose electrician's measuring tape device of claim 1, wherein said measuring tape is 30 feet long, one-inch wide, and double-coated with nylon.

7. The multi-purpose electrician's measuring tape device of claim 1, wherein said measuring tape has a magnetic tip and a double end hook.

8. The multi-purpose electrician's measuring tape device of claim 1, wherein said case is rubberized.

9. The multi-purpose electrician's measuring tape device of claim 1, wherein said three-phase electrical wiring reference guide further comprises a plurality of measurement reference numbers with color coding to correlate to wire color phase and voltage, wherein each said measurement reference number of said plurality directly correlates to a respective circuit number within a panel.

10. The multi-purpose electrician's measuring tape device of claim 2, wherein said conduit bending reference data is adapted for use with electrical metal tubing (EMT), rigid metal conduit (RMC), and intermediate metal conduit (IMT), wherein said conduit bending reference data further comprises a first offset table displaying a plurality of offset angles, a related plurality of multipliers, and a related plurality of shrinkage per inch of offset depth factors, and wherein said conduit bending reference data further comprises a second offset angle table displaying a plurality of offset depths, a related plurality of measurement distances between marks, and a related plurality of shrinkage amounts.

11. A multi-purpose electrician's device, comprising:
a case;
a tape with measured length markings indicated thereon, said tape retractably carried within said case,
wherein said measured length markings further comprise numerical measurement indicators, and
wherein said numerical measurement indicators are colorized according to a pattern,
said pattern further comprising dual-coloration for each said numerical measurement indicator,
said dual-coloration further comprising a first color printed in the upper region of each said numerical measurement indicator and a second color printed in the lower region of each said numerical measurement indicator,
wherein each said first color is one of a plurality of high voltage wire colors,
wherein each said second color is one of a plurality of low voltage wire colors,
wherein said pattern further comprises a correspondence for each said numerical measurement indicator with a numerical circuit reference,
wherein said numerical circuit reference defines one phase of a three phase electrical wiring system, and
wherein said phase defines said first color and said second color.

12. The device of claim 11, wherein said phase is selected from said three phases of A, B, and C, and said first color is selected from said plurality of high voltage wire colors further comprising brown, orange and yellow wire colors, respectively, for each said phase.

13. The device of claim 11, wherein said phase is selected from said three phases of A, B, and C, and said second color is selected from said plurality of low voltage wire colors further comprising black, red, and blue wire colors, respectively, for each said phase.

14. The device of claim 11, further comprising one or more additional features selected from the group consisting of laser-assisted measurement features and leveling components.

15. The device of claim 11, wherein said measured length markings further comprise said dual-coloration corresponding to said numerical measurement indicators proximate thereto.

16. A method of electrical wiring, comprising the steps of:
identifying a circuit with a number in a panel for installation;
identifying an electrical element to be installed to said circuit;
obtaining an electrician's measuring tape comprising a three-phase electrical wiring determination reference guide;
viewing a color coded measurement numeral on said guide that corresponds to said number of said circuit; and
installing a wire with the same color as said color coded measurement numeral.

17. The method of claim 16, wherein said electrician's measuring tape further comprises a conduit bending reference, and further comprising the steps of:
identifying a span and offset angle for a conduit;
viewing said conduit bending reference for said offset angle;
selecting a length of conduit according to said reference;
marking said conduit according to said reference; and
bending said conduit according to said offset angle at said marks.

18. The method of claim 16, wherein said offset angle is selected from a group consisting of angles 22½°×22½°, 30°×30°, 45°×45°, and 60°×60°.
